(19) United States
(12) Patent Application Publication
(10) Pub. No.: US 2013/0314254 A1
(43) Pub. Date: Nov. 28, 2013

(54) FLOOD-ACTUATED ROADBLOCK BARRIER GATE

(71) Applicant: John D. Neff, Austin, TX (US)

(72) Inventor: John D. Neff, Austin, TX (US)

(21) Appl. No.: 13/957,432

(22) Filed: Aug. 2, 2013

Related U.S. Application Data
(63) Continuation-in-part of application No. 11/897,276, filed on Aug. 27, 2007, now abandoned.

(51) Int. Cl. E01F 13/06; G08G 1/07

(52) U.S. Cl. CPC E01F 13/06; G08G 1/07
USPC 340/907; 404/6

(57) ABSTRACT

Horizontal road barrier gates pivot on vertical posts to swing horizontally across a flooded roadway to block traffic. Floodwater contact plates or paddles on the road barrier gate bottoms are configured and positioned to move the road barrier gates from the force of the floodwater to swing the road barrier gates horizontally across the roadway to block traffic from crossing the flooded road from both directions. A heavy tension spring on each barrier gate normally keeps the road barrier gate off the road and allows the barrier gate to pivot from obstructing the traffic back to its original non-blocking position once flood water recedes.

### CROSS-REFERENCE TO RELATED APPLICATIONS

The present utility patent application is a continuation-in-part of applicant's utility patent application Ser. No. 11/897,276 filed Aug. 27, 2007.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

### Field of the Invention

The present invention relates to road barriers and particularly to a flood-actuated road barrier which automatically responds to flooding conditions on a roadway to block traffic from traveling on the flooded roadway, and which comprises a flood roadblock gate system that is moved by the force of river or stream floodwater flowing over a road and which crosses over the road thereby blocking and preventing vehicles from driving into the floodwater on the road; the flood roadblock gate system comprises two gates, one gate for each side of the road where the stream or river would cross the road, each gate having one or more floodwater contact plates or paddles on the bottom thereof configured and positioned to move the gate from the force of the floodwater to block traffic from crossing the flooded road from both directions; a heavy spring on each gate keeps the gate off the road and allows the gate to pivot from obstructing the traffic back to its original non-blocking position once flood water recedes.

### Description of Related Art Including Information Disclosed Under 37 CFR 1.97 and 1.98

Flooded roadways are dangerous for vehicles to drive through. Damage may occur to the vehicle, or worse yet, the driver and passengers may lose their lives. The depth of the water is hard to gauge and often looks shallower than it is. Indicating signs and lights have been developed to alert the driver that the floodwater over the road is too deep to drive through. These flood warning indicators are not often posted at stream or river crossings, but even when they are posted, drivers do not tend to heed their warnings.

Examples of built-in roadway water barriers which divert floodwater from road surfaces are shown in U.S. Patent Application No. 20060072969 and U.S. Pat. Nos. 7,114,879; 6,623,210; 6,623,209; 6,338,594; 6,309,730 and 5,460,462. However, these examples are not designed to stop traffic from passing through a flooded road.

U.S. Pat. No. 7,037,031, issued May 2, 2006 to Haynie, is for an automatic barricade for low water crossings which includes a trench across a road that is covered by a grate allowing vehicular traffic during normal dry weather. Inside the trench is a series of barricade elements, each of which includes a float. When rising water fills the trench to a predetermined level, each float rises and elevates the elements above the road. The barricade elements are sufficiently robust and intimidating to deter motorists from driving over them but are spaced apart to be light enough to be easily actuated by the float. The barricade elements are sufficiently close together that vehicles cannot pass between them. In another embodiment, a sensor is adjacent the trench to detect rising water and communicates with a motor connected to the barricade elements for raising them to a traffic blocking position.

U.S. Pat. No. 4,879,545, issued Nov. 7, 1989 to Aguilar, provides a safety indicator device for low water crossing for signaling danger from floodwater over a low water crossing area. The device has a support post, a message panel, and flashing lights in electrical connection with an energy source, the electrical connection being completed by triggering a switch lever by either a tank float rigidly mounted to a bottom end of a centrally disposed elongate guide member or by a donut-shaped tank float received about the elongate guide member and stopped by a stop member, either the rigidly mounted float pushing the elongate rod upwards and triggering the switch lever, or the donut shaped tank float and stop pushing the elongate rod upwards and triggering the switch lever.

U.S. Pat. No. 2,607,835, issued Aug. 19, 1952 to Bonar, shows an indicator placed on the side of the road, which is actuated by rising water, to indicate that the water height over the road is dangerous for vehicles to drive through.

U.S. Pat. No. 874,608, issued Dec. 24, 1907 to Luther, claims a danger signal which is responsive to rising water or fire and which uses lights or bells to indicate the bridge, railway, or road is not passable.

U.S. Pat. No. 6,688,028, issued Feb. 10, 2004 to Backe, describes a condition responsive traffic sign, wherein the controller may detect or sense a loss of electrical power, a drop in temperature below freezing, moisture (precipitation) or water (flooding) in the environment. A vertically disposed placard has two sections, one disposed over the other, with the upper section of the placard attached to a pole, standard or other mount. A hinge connects the bottom perimeter edge of the fixed section with the top perimeter edge of the lower, pivotable section, allowing the front surface of the pivotable section to rotate and fold flat against the front surface of the upper, fixed section. A catch mechanism releaseably holds the two sections flat against each other, preventing the pivotable section from unfolding. An electrical controller is attached to the back surface of the fixed section of the placard and senses when a condition to which the sign is responsive occurs. Upon the occurrence, the controller causes release of the catch mechanism, allowing the pivotable section to unfold under the force of a bias (e.g., spring) and/or gravity, or by an electric motive mechanism to display the front surfaces of both sections of the placard. When the condition no longer exists, the device may be returned to its folded configuration manually or electromotively (if so equipped). When the placard is unfolded, the front surfaces of the placard together display a first sign item, and when the placard is folded, the back surface of the pivotable section is presented and can display a second sign item. Therefore, alternative sign items may be displayed, depending on whether the sections of the placard are folded or unfolded.

U.S. Pat. No. 116,247, issued Jun. 20, 1871 to Way, indicates a pivotable flood-gate for erecting over a stream, which during a flood is pushed open by the floodwater, and which closes after the flooding by means of heavy iron or steel springs.

U.S. Pat. No. 944,210, issued Dec. 21, 1909 to Rhodes, puts forth a spring-closed flood gate which is placed across a stream.

U.S. Pat. No. 6,646,559, issued Nov. 11, 2003 to Smith, concerns a method and apparatus for activating warning devices. The invention provides a system and method for activating one or more warning devices, such as weather warning sirens, environmental warning devices, gates that may automatically close in order to alter the effect or course of the flash flood or to divert traffic away from the flash flood, and the like, from a remote or central location. Warning devices situated across geographically dispersed areas can be remotely controlled from a central location, such as a weather center, on the basis of detected and predicted weather patterns and other environmentally hazardous events. One or more warning devices can be quickly and easily activated through a computer-implemented user interface that allows a user to select a group of warning devices that are in the path of an approaching hazardous event. Each warning device is activated through a communication line that transmits an activation code to each device. Each device provides confirmation that it has been activated, and the resulting activation is indicated on a computer screen.

What is needed is a system of pivotable road barriers which automatically close over the roadway to block traffic from traveling on the flooded roadway by the force of moving water flooding the roadway and which automatically open away from the roadway by the force of a tension means when the water recedes.

### BRIEF SUMMARY OF THE INVENTION

An object of the present invention is to provide a flood warning road barrier device automatically responding to flooding conditions on a roadway to block traffic from traveling on the flooded roadway comprising a system of pivotable road barriers with bottom water receiving paddles or panels which cause the barrier gates to automatically close over the roadway to block traffic by the force of moving water flooding the roadway and pushing against the paddles and which automatically open away from the roadway by the force of a tension means between each barrier gate and a pivot post when the water recedes to swing the road barrier gates back to the original position parallel to the roadway.

In brief, a flood-actuated road barrier which comprises a flood roadblock gate system that is moved by the force of river or stream floodwater flowing over a road and which crosses over the road thereby blocking and preventing vehicles from driving into the floodwater on the road. The flood road barrier gate system comprises two barrier gates, one barrier gate for each side of the road where the stream or river would cross the road. Each barrier gate has one or more floodwater contact plates or paddles on the bottom thereof to move the barrier gate using the force of the floodwater to block traffic from crossing the flooded road from both directions. A heavy spring on each barrier gate normally keeps the barrier gate off the road and allows the barrier gate to pivot from obstructing the traffic back to its original non-blocking position once flood water recedes.

An advantage of the present invention is that it provides a flood warning road barrier device automatically responding to flooding conditions on a roadway to block traffic from traveling on the flooded roadway comprising a system of pivotable road barriers which automatically close over the roadway to block traffic by the force of moving water flooding the roadway and which automatically open away from the roadway by the force of a tension means when the water recedes.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a top plan view of a section of a roadway crossing over a perpendicular waterway showing the tops of the road barrier gates of the present invention in the normal position parallel to the roadway on an upstream side of the roadway having the road barrier gates spaced apart so that there is no possible contact of the two road barrier gates and each of the road barrier gates pivots freely between the two positions of blocking and unblocking the roadway indicated by the dashed pivot lines;

FIG. 2 is a side elevational view of the section of the roadway crossing over the perpendicular waterway of FIG. 1, showing the end of the nearer road barrier gate pivot post with the road barrier gates in the normal aligned position parallel to the roadway on an upstream side of the roadway;

FIG. 3 is a top plan view of a section of a roadway crossing over a perpendicular waterway showing the tops of the road barrier gates of the present invention in the normal position parallel to the roadway on an upstream side of the roadway having the road barrier gates in parallel overlapping alignment having different tension strengths in the tension members so that overlapping road barrier gates swing across the roadway and swing back off of the roadway at different rates so that there is no contact between the two road barrier gates so that each of the road barrier gates pivots freely between the two positions;

FIG. 4 is a side elevational view of the section of the roadway crossing over the perpendicular waterway of FIG. 1, showing the ends of the road barrier gates in the normal overlapping positions parallel to the roadway on an upstream side of the roadway;

FIG. 5 is a top plan view of a section of the roadway crossing over the perpendicular waterway of FIG. 3 with the roadway flooded showing the tops of the barrier gates in the roadblock position stretching across the roadway perpendicular to the roadway blocking the travel lanes of the roadway and the sidewalks and further showing the rigid paddle extension portions extending perpendicularly away from the water receiving paddle to assist in allowing the flood water to push each road barrier gate into the perpendicular orientation to the roadway to completely block the flooded roadway;

FIG. 6 is a side elevational view of the section of the roadway crossing over the perpendicular waterway of FIG. 5, with the roadway flooded showing the front of the closer barrier gate in the roadblock position stretching across the roadway perpendicular to the roadway blocking the travel lanes of the roadway and the sidewalks;

FIG. 7 is a front elevational view of one of the barrier gates showing the lights and reflectors that face the flow of traffic during flooding;

FIG. 8 is a front elevational view of the other of the barrier gates showing the lights and reflectors that face the flow of traffic during flooding;

FIG. 9 is a front elevational view of a barrier gate having an alternate embodiment of the bottom water receiving paddle with the main body of the water receiving paddle in parallel alignment with the barrier gate and a rigid paddle extention portion extending perpendicularly away from the barrier gate;

FIG. 10 is an end elevational view of the barrier gate of FIG. 9 having an alternate embodiment of the bottom water receiving paddle with the main body of the water receiving paddle in parallel alignment with the road barrier gate and the rigid paddle extension portion extending perpendicularly away from the water receiving paddle and the road barrier gate;

FIG. 11 is a top plan view of a section of a roadway crossing over a perpendicular waterway showing the tops of the road barrier gates of the present invention in the normal position parallel to the roadway on an upstream side of the roadway, having two pair of road barrier gates spaced apart so that there is no possible contact of the two road barrier gates and each of the road barrier gates pivots on a pivot post between the two positions of blocking and unblocking the roadway, each pair of the road barrier gates being interconnected by a rigid connector element pivotally attached at each end of the rigid connector element to a mid-portion of one of the interconnected pair, the two pair of road barrier gates normally in a first position parallel to the roadway spaced apart from the travel lanes, the pivot posts spaced apart with a first pivot post of a first pair of interconnected road barrier gates positioned landward of a first bank of the waterway and a second pivot post of the first pair positioned further landward from the first post of the first pair by at least a length of a second road barrier gate and a first pivot post of a second pair of interconnected road barrier gates positioned landward of a second bank of the waterway and a second pivot post of the second pair positioned further landward from the first post of the second pair by at least a length of a second road barrier gate;

FIG. 12 is a top plan view of a section of the roadway crossing over the perpendicular waterway of FIG. 11 with the roadway flooded showing the tops of the barrier gates in the roadblock position stretching across the roadway perpendicular to the roadway blocking the travel lanes of the roadway and the sidewalks and showing each of the road barrier gates pivoted around a pivot post to swing over the roadway to a second position extending across the flooded roadway perpendicular to the roadway, a first pair of road barrier gates blocking vehicles from traveling from a first direction across the flooded roadway and a second pair of road barrier gates blocking vehicles from traveling from a second direction across the flooded roadway so that the two pair of road barrier gates together block vehicles from traveling over the flooded roadway from both sides of the flooded roadway with each of the further landward road barrier gates positioned over the roadway beyond the flood water so that vehicles will not drive into the flood water.

### DETAILED DESCRIPTION OF THE INVENTION

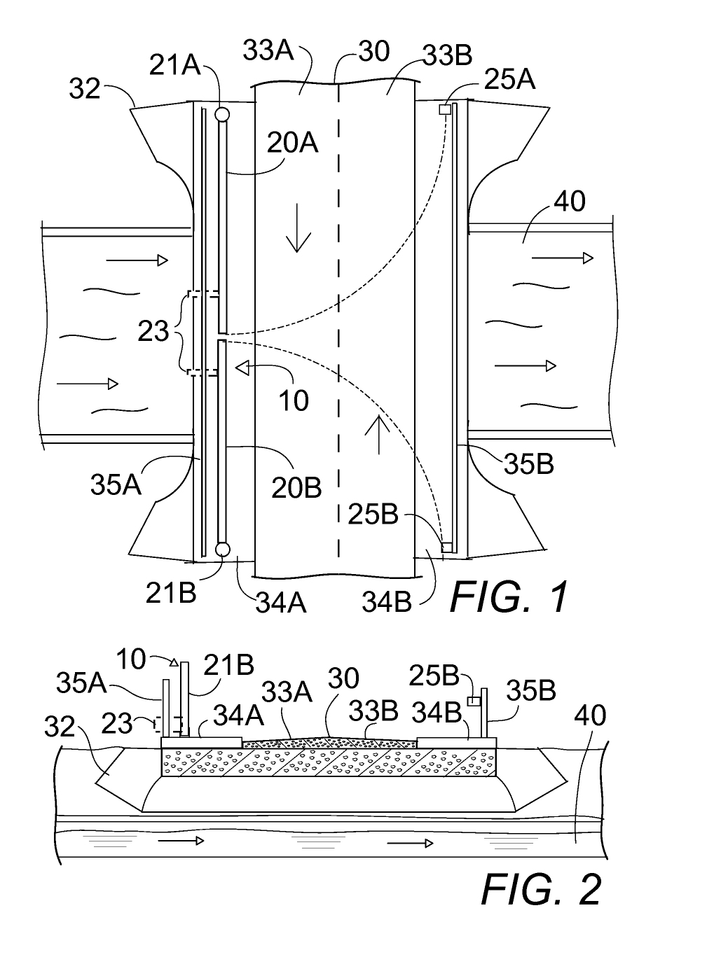

In FIGS. 1-12, a flood warning road barrier device 10, automatically responding to flooding conditions on a roadway to block traffic from traveling on the flooded roadway, comprises horizontally extending barrier gates 20A and 20B and alternate pairs of barrier gates 20A and 20D and 20B and 20E with bottom water receiving paddles 22A and 22B, respectively, for pivoting the barrier gates around vertical pivot posts 21A and 21B and 21D and 21E when flood water 40 exceeds the height of the roadway and the paddles swing the road barrier gates horizontally around the vertical pivot posts and across the roadway 30 so that the gates block traffic flow from both directions on either side of the flooded roadway 30.

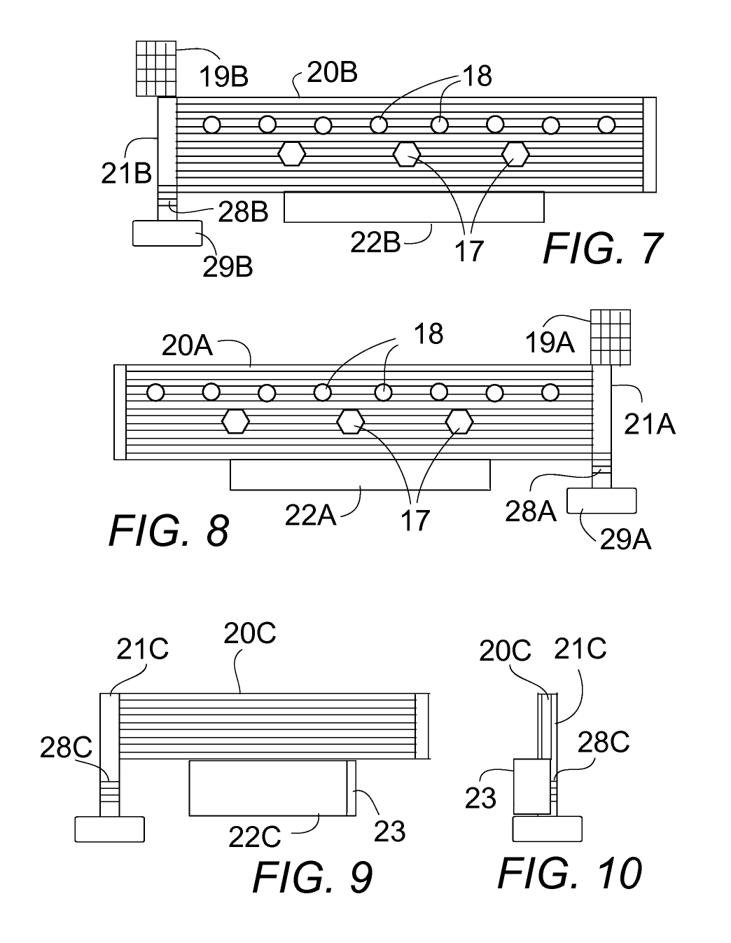

In FIGS. 1-4, at least one road barrier gate, for a one-way road, and preferably two horizontally extending road barrier gates 20A and 20B for a two-way road, are each mounted on a vertical pivot post 21A and 21B, respectively, on an upstream side of a roadway 30 having a passage of water 40 running beneath the roadway 30, with the water flowing approximately perpendicular to the roadway. Each road barrier gate 20A and 20B comprises a rigid barrier structure for blocking traffic from one direction on the roadway, such as the two way traffic in a first lane 33A and a second lane 33B, as shown in FIGS. 1, 3 and 5, and a bottom solid water receiving paddle 22A and 22B extending vertically below the rigid barrier structure, as shown in FIGS. 7 and 8, with a bottom of the water receiving paddle above and adjacent to a level of the roadway 30. A tension member 28A and 28B is attached between the rigid barrier structure and the pivot post 21A and 21B to retain the road barrier gate 20A and 20B normally in a first position parallel to the roadway, as shown in FIGS. 1-4, spaced apart from the travel lanes 33A and 33B on the roadway 30.

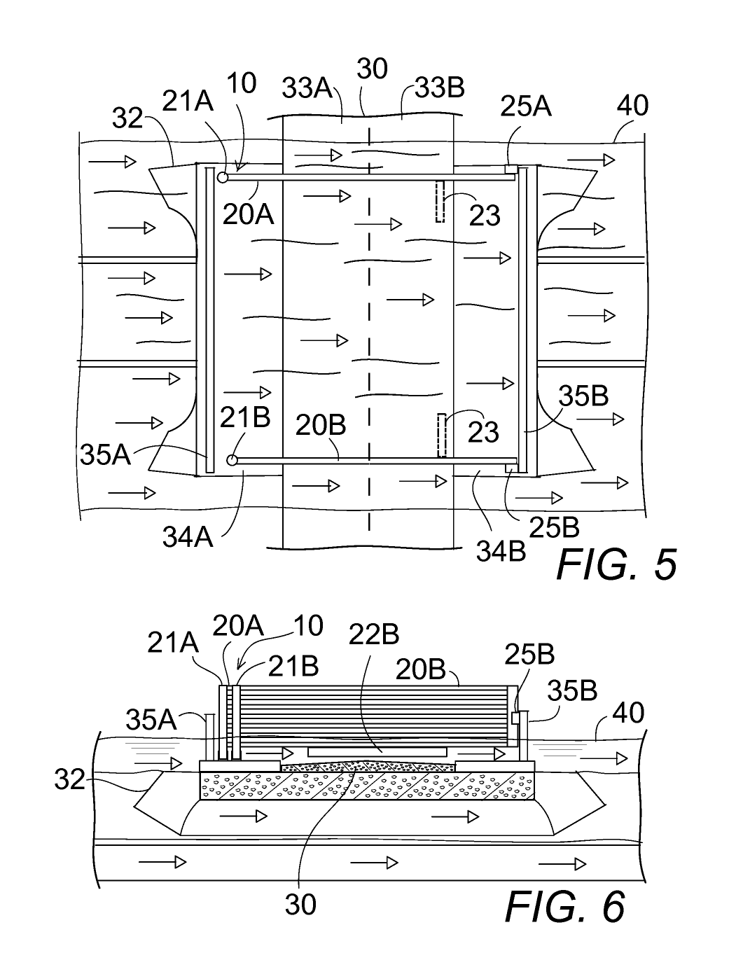

In FIGS. 5 and 6, when a water level in the water passage 40 is higher than the top surface of the roadway 30 and overflowing the roadway to cause flooding of the roadway, the water receiving paddle 22A is configured and positioned to be moved by the water flowing over the roadway with a force exceeding a force of the tension member 28A and 28B to cause each road barrier gate 20A and 20B to pivot approximately ninety degrees on the vertical pivot post 21A and 21B to swing horizontally across the travel lanes 33A and 33B into a second position perpendicular to the roadway extending across the travel lanes to block vehicles from traveling over the flooded roadway, as shown in FIGS. 5 and 6. Preferably, magnetic stopping means 25A and 25B stop the road barrier gates in the second position substantially perpendicular to the direction of travel on the roadway to block the travel lanes.

After the water level recedes from the roadway, the tension members 28A and 28B overcome the magnetic stopping means and cause the road barrier gates 20A and 20B to pivot back into the first position parallel to the roadway to allow vehicles to travel on the roadway, as shown in FIGS. 1-4.

In FIGS. 1-4, the road barrier gate preferably comprises two separate road barrier gates 20A and 20B each mounted on a pivot post 21A and 21B on an upstream side of a two-way roadway 30 having a water passage 40 running beneath the roadway. Each of the road barrier gates is normally in a first position parallel to the roadway spaced apart from the travel lanes 33A and 33B, the pivot posts spaced apart with a first pivot post 21A positioned landward of a first bank of the waterway 40 and a second pivot post 21B positioned landward of a second bank of the waterway 40 so that each of the road barrier gates pivots around a pivot post to swing over the roadway to a second position extending across the flooded roadway perpendicular to the roadway, as shown in FIGS. 5 and 6. The first road barrier gate 20A blocking vehicles from traveling from a first direction in one lane 33A across the flooded roadway and a second road barrier gate 20B blocking vehicles from traveling from a second direction in an opposite lane 33B across the flooded roadway so that the pair of road barrier gates together block vehicles from traveling over the flooded roadway from both sides of the flooded roadway.

Means are provided for preventing each of the road barrier gates from interfering with the pivoting motion of the other of the road barrier gates.

In FIGS. 1 and 2, the means for preventing one road barrier gate 20A from interfering with the pivoting motion of the other road barrier gate 20B comprises positioning each of the road barrier gates spaced apart from an entire length of the other of the road barrier gates so that there is no possible contact of the two road barrier gates so that each of the road barrier gates pivots freely between the two positions of blocking and unblocking the roadway, indicated by the dashed pivot lines in FIG. 1.

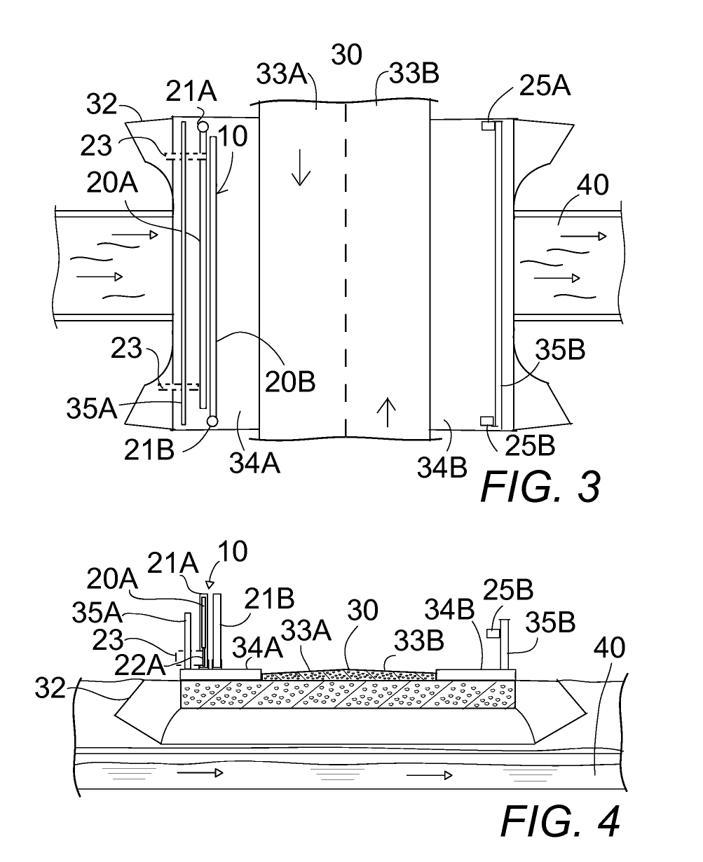

In FIGS. 3 and 4, the means for preventing one road barrier gate 20A from interfering with the pivoting motion of the other road barrier gate 20B comprises providing different tension strengths in the tension members 28A and 28B, shown in FIGS. 7 and 8, so that overlapping road barrier gates swing across the roadway and swing back off of the roadway at different rates so that there is no contact between the two road barrier gates so that each of the road barrier gates pivots freely between the two positions.

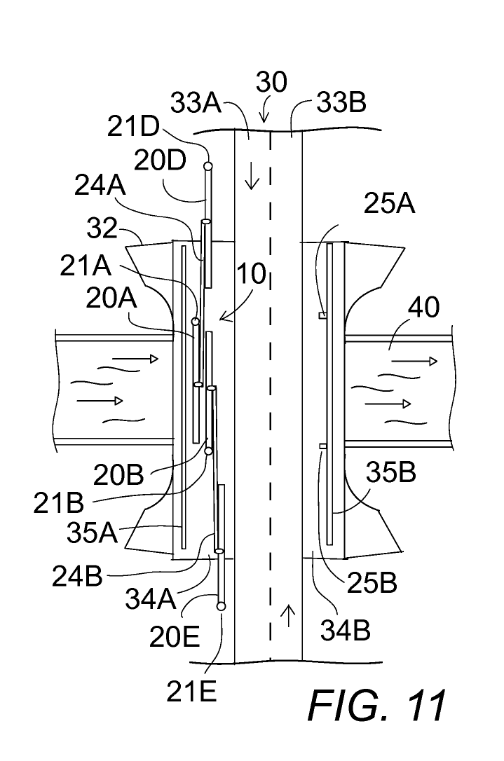

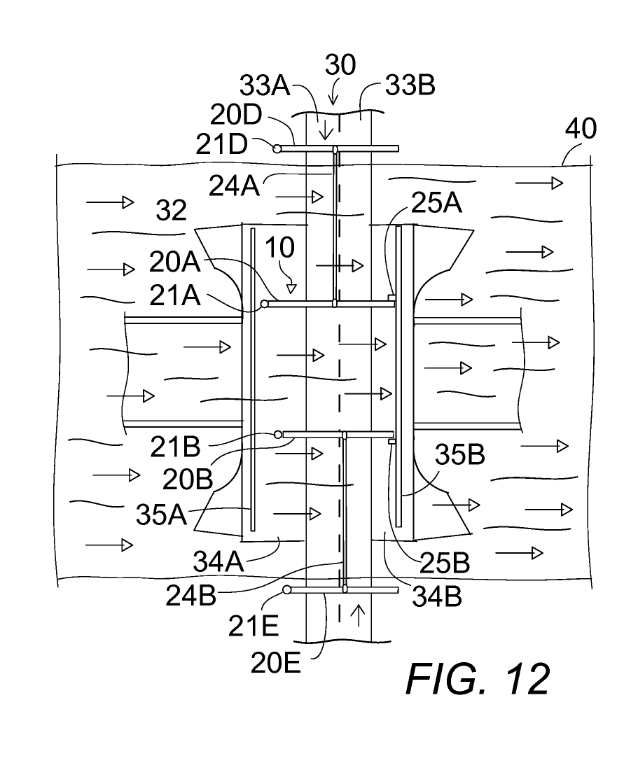

In FIGS. 11 and 12, for widespread flooding, two pair of road barrier gates are provided. Each pair of road barrier gates interconnected by a rigid connector element 24A and 24B pivotally attached at each end of the rigid connector element to a mid-portion of one of the interconnected pair of road barrier elements, such as the rigid connector element 24A between one pair of road barrier gates 20A and 20D and the rigid connector element 24B between the other pair of road barrier gates 20B and 20E.

In FIG. 11, the two pair of road barrier gates are normally in a first position parallel to the roadway 30 spaced apart from the travel lanes 33A and 33B. The pivot posts spaced apart with a first pivot post 21A of a first pair of interconnected road barrier gates 20A and 20D positioned landward of a first bank of the waterway 40 and a second pivot post 21D of the first pair positioned further landward from the first post of the first pair by at least a length of a second road barrier gate 20D. A first pivot post 21E of a second pair of interconnected road barrier gates 20B and 20E is positioned landward of a second bank of the waterway 40 and a second pivot post 21E of the second pair positioned further landward from the first post of the second pair by at least a length of a second road barrier gate 20E so that each of the road barrier gates pivots around a pivot post to swing over the roadway to a second position extending across the flooded roadway 30 perpendicular to the roadway, as shown in FIG. 12. The first pair of road barrier gates 20A and 20D blocking vehicles from traveling from a first direction in lane 33A across the flooded roadway and a second pair of road barrier gates 20B and 20E blocking vehicles from traveling from a second direction in lane 33B across the flooded roadway 30 so that the two pair of road barrier gates together block vehicles from traveling over the flooded roadway from both sides of the flooded roadway with each of the further landward road barrier gates 20D and 20E positioned over the roadway beyond the flood water so that vehicles will not drive into the flood water.

The road barrier gates 20A and 20B are each longer than the width of the travel lanes 33A and 33B of the roadway and the means for stopping the rigid barrier structure in a second position comprises a barrier structure stop 25A and 25B, respectively, on the opposite side of the roadway from the pivot post 21A and 21B, the barrier structure stop comprising a rigid structure contacting the rigid barrier structure and a magnetic attraction means for assisting in retaining the rigid barrier structure in contact the barrier structure until the flood waters recede and the tension means 28A and 28B swings the barrier structure back to the first position.

The magnetic attraction means assists the force of the flood waters in retaining the road barrier gate in contact with the barrier structure stop 25A and 25B until the flood waters recede and the tension means 28A and 28B exerts a force greater than the magnetic attraction means to swing the road barrier gate back to the first position.

A barrier structure extension may be added if needed for blocking passage of non-vehicular traffic. If an extra gate is needed to prevent any foot traffic, bikes or motorized vehicles from the area of rising water further up the road this additional gate can be attached to the flood actuated gate by a fixed length rod. Rod can be made of metals, plastics, wood, or any material that is rigid. Rod length varies depending on the distance between the road barrier gate and an opposite side of the bridge or other road structure over the water.

In FIGS. 7 and 8, showing the sides of the barrier gates facing traffic on the roadway, at least one light 18 and preferably an array of lights on each barrier gate 20A and 20B signals traffic at night. A means for activating the preferably battery powered flashing lights 18 comprises a pair of contacts closing an electric circuit between at least one battery 29A and 20B, housed in the pivot post base, and the flashing lights when the barrier structure contacts the means for stopping the barrier structure 25A and 25B. The barrier gate preferably also further comprises a plurality of reflectors 17 visible to traffic at night.

The means for activating the at least one battery powered flashing light comprises a pair of contacts closing an electric circuit between at least one battery and the at least one flashing light. At least one solar panel 19A and 19B may be connected to the battery 29A and 29B for charging the battery.

In use, the flood actuated barrier gates 20A and 20B are closed due to rising water, when water 40 flowing with a minimum force of 50 lbs per square foot at a depth of at least 6″ over the roadway 30 overcomes the tension apparatus (spring, cords, flexible material). One barrier gate 20B moves clockwise and the other barrier gate 20A moves counterclockwise by the force of the moving water 40 and when fully closed each barrier gate will be blocking the roadway 30 and walkways 34A and 34B being immersed in the rising water with the barrier gates parallel to the rising water 40 and perpendicular to the road and walkway.

When the barrier gates are open or at rest, they are parallel to the road and perpendicular to the flow or potential flow of water.

Barrier gates can be of variable height, length, and composition. Each barrier gate can be offset to the other gate as to prevent the gates from hitting each other when being open or closed.

When the gate is closed by the force of the rising water, the attraction force of the magnet will be less than the tension of the spring, so once the rising water is retreating, and the force of the wafer is less than the force of the tension apparatus, the tension apparatus will bring the gate back to its open position, as in FIGS. 1 and 2. The fixed stops fabricated of any material prevent the gate for going past its open position.

Each tension member 28A and 28B can be fabricated of a spring, a rubber cord, or other flexible material returning to its original shape after extension which requires a minimum of 50 lbs of force exerted on it to fully extend it. One end of the tension member is attached to the movable portion of the barrier gate and the other to a fixed base of the barrier gate.

The plate or paddle 22A and 22B attached to the barrier gate can be of a variable size of 1 square foot to 5 square feet, and fabricated of varied materials resistant to water and positioned at different heights off the ground. In an alternate embodiment of the paddle 22C in FIGS. 7 and 8, the main portion of the paddle 20C is parallel to the barrier gate 20C and an orthogonal paddle extension 23 is perpendicular to the barrier gate 20C.

Plates or paddles can also be curved. When the plates or paddles have a force of water pushing on them greater than 50 lbs/sq-ft, the barrier gates will pivot over to block the roadway 30.

The tension of the tension members and size of the metal plates or paddles can be increased to compensate for any extra weight of the barrier gate, such as a barrier gate which is extra long for a wide roadway or has an extension gate for a sidewalk.

It is understood that the preceding description is given merely by way of illustration and not in limitation of the invention and that various modifications may be made thereto without departing from the spirit of the invention as claimed.

What is claimed is:

1. A flood warning road barrier device automatically responding to flooding conditions on a roadway to block traffic from traveling on the flooded roadway, the device comprising:
at least one road barrier gate pivotally mounted on a vertical pivot post on an upstream side of a roadway having a water passage running beneath the roadway with the water flowing approximately perpendicular to the roadway, the at least one horizontally extending road barrier gate comprising at least one rigid barrier structure for blocking traffic traveling in at least one lane of the roadway from at least one direction during flood conditions on the roadway, and further comprising a tension member attached between the road barrier gate and the pivot post to retain the at least one road barrier gate normally in a first position parallel to the roadway spaced apart from at least one travel lane on the roadway, and further comprising a bottom solid water receiving paddle extending vertically below the rigid barrier structure with a bottom of the water receiving paddle above and in close proximity to a top surface of the roadway so that when a water level in the water passage is higher than the top surface of the roadway and overflowing the roadway to cause flooding of the roadway, the water receiving paddle is configured and positioned to be moved by the water flowing over the roadway with a force exceeding a force of the tension member to cause the at least one road barrier gate to pivot ninety degrees around the vertical pivot post to swing horizontally over the at least one travel lane into a second position perpendicular to a direction of travel in the at least one travel lane on the roadway extending horizontally across the at least one travel lane to block vehicles from traveling over the flooded roadway, and further comprising means for stopping the road barrier gate in the second position substantially perpendicular to the roadway extending horizontally across the roadway to block the at least one travel lane, and after the water level recedes from the roadway, the tension member causing the road barrier gate to pivot back into the first position parallel to the roadway to allow vehicles to travel on the roadway; thereby providing a flood warning road barrier device automatically responding to flooding conditions on a roadway to block traffic from traveling on the flooded roadway.

2. The device of claim 1 wherein the at least one road barrier gate comprises a pair of road barrier gates each mounted on a pivot post on an upstream side of a two-way roadway having a water passage running beneath the roadway, each of the road barrier gates normally in a first position parallel to the roadway spaced apart from the travel lanes, the pivot posts spaced apart with a first pivot post positioned landward of a first bank of the waterway and a second pivot post positioned landward of a second bank of the waterway so that each of the road barrier gates pivots around a pivot post to swing over the roadway to a second position extending across the flooded roadway perpendicular to the roadway, a first road barrier gate blocking vehicles from traveling from a first direction across the flooded roadway and a second road barrier gate blocking vehicles from traveling from a second direction across the flooded roadway so that the pair of road barrier gates together block vehicles from traveling over the flooded roadway from both sides of the flooded roadway.

3. The device of claim 2 further comprising means for preventing each of the road barrier gates from interfering with the pivoting motion of the other of the road barrier gates.

4. The device of claim 3 wherein the means for preventing each of the road barrier gates from interfering with the pivoting motion of the other of the road barrier gates comprises positioning each of the road barrier gates spaced apart from an entire length of the other of the road barrier gates so that there is no possible contact of the two road barrier gates so that each of the road barrier gates pivots freely between the two positions.

5. The device of claim 3 wherein the means for preventing each of the road barrier gates from interfering with the pivoting motion of the other of the road barrier gates comprises providing different tension strengths in the tension members so that overlapping road barrier gates swing across the roadway and swing back off of the roadway at different rates so that there is no contact between the two road barrier gates so that each of the road barrier gates pivots freely between the two positions.

6. The device of claim 1 wherein the at least one road barrier gate comprises two pair of road barrier gates each of the road barrier gates mounted on a pivot post on an upstream side of a two-way roadway having a water passage running beneath the roadway, each pair of the road barrier gates interconnected by a rigid connector element pivotally attached at each end of the rigid connector element to a mid-portion of one of the interconnected pair, the two pair of road barrier gates normally in a first position parallel to the roadway spaced apart from the travel lanes, the pivot posts spaced apart with a first pivot post of a first pair of interconnected road barrier gates positioned landward of a first bank of the waterway and a second pivot post of the first pair positioned further landward from the first post of the first pair by at least a length of a second road barrier gate and a first pivot post of a second pair of interconnected road barrier gates positioned landward of a second bank of the waterway and a second pivot post of the second pair positioned further landward from the first post of the second pair by at least a length of a second road barrier gate so that each of the road barrier gates pivots around a pivot post to swing over the roadway to a second position extending across the flooded roadway perpendicular to the roadway, a first pair of road barrier gates blocking vehicles from traveling from a first direction across the flooded roadway and a second pair of road barrier gates blocking vehicles from traveling from a second direction across the flooded roadway so that the two pair of road barrier gates together block vehicles from traveling over the flooded roadway from both sides of the flooded roadway with each of the further landward road barrier gates positioned over the roadway beyond the flood water so that vehicles will not drive into the flood water.

7. The device of claim 1 wherein the at least one road barrier gate is longer than the width of the travel lanes of the roadway and the means for stopping the at least one road barrier gate in a second position comprises at least one road barrier gate stop on the opposite side of the roadway from the pivot post, the at least one road barrier gate stop comprising at least one rigid structure contacting the at least one road barrier gate.

8. The device of claim 7 further comprising a magnetic attraction means for assisting in retaining the at least one road barrier gate in contact with the at least one road barrier gate until the flood waters recede and the tension means exerts a force greater than the magnetic attraction means to swing the at least one road barrier gate back to the first position.

9. The device of claim 1 further comprising at least one light on the at least one road barrier gate for signaling traffic at night and a means for activating the at least one light when the barrier structure contacts the means for stopping the barrier structure.

10. The device of claim 9 wherein the at least one light comprises at least one battery powered flashing light on the at least one road barrier gate and the means for activating the at least one battery powered flashing light comprises a pair of contacts closing an electric circuit between at least one battery and the at least one flashing light.

11. The device of claim 10 further comprising at least one solar panel connected to the at least one battery for charging the at least one battery.

12. The device of claim 1 wherein the barrier gate further comprises a plurality of reflectors on the at least on road barrier gate visible to traffic at night.

13. The device of claim 1 further comprising a barrier structure extension of the road barrier gate for blocking passage of non-vehicular traffic.

14. The device of claim. 1 wherein the bottom water contacting paddle further comprises a rigid paddle extension portion extending perpendicularly away from the water receiving paddle and the road barrier gate on a water receiving side to allow the flood waters to exert a greater push on the road barrier gate as the road barrier gate approached a perpendicular orientation to the roadway to insure that the road barrier gate reaches a full perpendicular orientation to the roadway during flooding.
